(19) United States
(12) Patent Application Publication
(10) Pub. No.: US 2008/0157722 A1
(43) Pub. Date: Jul. 3, 2008

(54) APPROPRIATE BATTERY EXCHANGE

(75) Inventors: Yasushi NOBUTAKA, Osaka (JP); Hiroshi Kamiya, Osaka (JP); Masakazu Hayashi, Tokyo (JP); Masaaki Konno, Tokyo (JP); Wenbeen Yao, Tokyo (JP)

Correspondence Address: YOUNG & THOMPSON, 209 Madison Street, Suite 500, ALEXANDRIA, VA, 22314, US

(73) Assignee: NEC SYSTEM TECHNOLOGIES, LTD., Osaka-shi (JP)

(21) Appl. No.: 11/947,868

(22) Filed: Nov. 30, 2007

(30) Foreign Application Priority Data
Nov. 30, 2006 (JP) 2006-323928

(51) Int. Cl. H02J 7/00

(52) U.S. Cl. 320/137

(57) ABSTRACT

In a battery exchange system for facilitating exchange at appropriate intervals of a chargeable battery with another fully charged chargeable battery for charging, a user device having characteristic identification information reads a serial number from a battery when the battery is installed and transmits to a control device correspondence information in which the identification information and the serial number have been placed in correspondence with each other. A charging device reads the serial number from a battery when charging of the battery has been completed and transmits the serial number to the control device. The control device calculates a scheduled charging time of the battery having the serial number that has been transmitted from the charging device based on the time of reception of the correspondence information that was transmitted from user device and, before the calculated scheduled charging time, carries out notification prompting battery exchange.

This application is based upon and claims the benefit of priority from Japanese Patent Application No. 2006-323928 filed on Nov. 30, 2006, the content of which is incorporated by reference.

### BACKGROUND OF THE INVENTION

1. Field of the Invention

The present invention relates to a battery exchange system, a user device, a charging device, a control device, a method, and a recording medium for exchanging batteries, and more particularly, relates to a battery exchange system, a user device, a charging device, a control device, a method, and a recording medium for exchanging batteries that require charging.

2. Description of the Related Art

In recent years, Japan is witnessing the graying of its population as the numbers of senior citizens and people needing care increase with every year. Many of these individuals (hereinbelow referred to as the senior citizens) are living alone, and a communication means suitable for ascertaining whether an individual is in need of care is therefore of crucial importance.

A fixed telephone in a private residence can be offered as a normal communication means, but even in a private residence, a senior citizen would have difficulty making a call if he or she should become unable to move in a location such as a bathroom that is distant from the fixed telephone.

As a result, senior citizens are often provided with portable terminals so that they can stay in contact.

However, batteries are used as the power supply means for an electronic apparatus such as a portable terminal, and chargeable batteries that can be reused by charging the batteries have become mainstream.

These chargeable batteries must be charged either at regular intervals or at irregular intervals that depend on the state of use. Many portable terminals are provided with the capability for displaying the residual percentage of the chargeable battery so that the owner of the portable terminal will be aware of the time intervals at which charging of the battery of the portable terminal is necessary.

Upon referring to the battery residual percentage of the chargeable battery displayed on the portable terminal and determining that the battery of the portable terminal must be charged, special charging equipment is used to charge the battery.

In recent years, systems have been considered that allow charging of the battery of a portable terminal even when charging equipment is not available, such as during a trip. More specifically, systems have been considered in which charging stations having charging equipment for charging portable terminals are established at prescribed locations, and portable terminals can be charged at these charging stations.

However, the problem remains that users may encounter difficulties in using the above-described charging stations due to the lack of information regarding the vacancy and location of these charging stations.

However, a method has been disclosed in JP-A-2003-348757A in which the residual power in a portable terminal is monitored, a control server is notified when the residual power falls below a prescribed threshold value, and a suitable charging station is then reserved in the control server.

However, such a method has the drawback that, even when a senior citizen is provided with a portable terminal, the concern remains that the senior citizen may not be used to using electronic equipment and therefore may allow the battery to run down without charging the chargeable battery.

In response, a method can be considered in which, using the method disclosed in JP-2003-348757A, the control server monitors the residual battery power of the portable terminal, and when the residual battery power falls below a prescribed threshold value, someone such as a helper is dispatched to the residence of the senior citizen that owns the portable terminal to charge the chargeable battery of the portable terminal.

However, the above-described method has the drawback that the capability for monitoring the residual battery power must be provided in the portable terminal. The method further has the problem that the residual battery power must be calculated based on the state of use of the portable terminal, thereby increasing the scale of the portable terminal as a device. A further problem is an increase in the processing burden on the portable terminal.

### SUMMARY OF THE INVENTION

It is an object of the present invention to provide a battery exchange system, a user device, a charging device, a control device, a method, and a recording medium that can facilitate the exchange of a chargeable battery with another charged battery for charging at appropriate intervals.

According to the present invention for achieving the above-described object, a battery exchange system includes: a user device belonging to a user, the user device being supplied with power from a battery having a characteristic serial number; a charging device for charging the battery; and a control device for managing the state of battery charge; wherein:

the user device has characteristic identification information, reads the serial number from the battery when the battery is installed, and places the identification information and the serial number in correspondence with each other and transmits these items of information as correspondence information to the control device;

the charging device reads the serial number from the battery when charging of the battery has been completed and transmits this serial number to the control device; and

the control device receives and stores the correspondence information that has been transmitted from the user device, receives the serial number that has been transmitted from the charging device, calculates a scheduled charging time that is next scheduled for the battery having the serial number based on the time of reception of correspondence information that has been transmitted from the user device, stores the serial number transmitted from the charging device and the scheduled charging time in correspondence with each other as charging information, and, before the scheduled charging time that has been stored, displays the identification information that is stored in correspondence with the serial number of that battery to carry out notification to prompt battery exchange.

In the present invention of the above-described configuration, in a user device that is supplied with power from a battery having a characteristic serial number and that has characteristic identification information: the serial number is read from the battery when the battery is installed, the identification information and the serial number are placed in correspondence with each other and are transmitted as correspondence information to the control device; in a charging device that carries out charging of the battery: the serial number is read from the battery when charging of the battery is completed and this serial number is transmitted to the control device; and in the control device that controls the state of battery charge: the correspondence information that has been transmitted from the user device is received and stored, the serial number that has been transmitted from the charging device is received, a scheduled charging time for the battery having the serial number is calculated based on the time of reception of the correspondence information that was transmitted from the user device, the serial number that was transmitted from the charging device and the scheduled charging time are stored in correspondence with each other as charging information, and notification is carried out to prompt battery exchange before the stored scheduled charging time.

In this way, the scheduled charging time of a battery is calculated based on the time of installation of a battery in the user device and notification then carried out before the scheduled charging time, whereby battery shutoff of the user device can be easily prevented.

As a result, a battery can easily be exchanged with another charged battery for charging at an appropriate time.

The above and other objects, features, and advantages of the present invention will become apparent from the following description with reference to the accompanying drawings which illustrate an example of the present invention.

### BRIEF DESCRIPTION OF THE DRAWINGS

FIG. 1 shows a first embodiment of the battery exchange system of the present invention;

FIG. 2 shows an example of the configuration of the battery shown in FIG. 1;

FIG. 3 is a sequence chart for explaining the battery exchange method in the battery exchange system shown in FIG. 1 and FIG. 2;

FIG. 4 shows an example of the structure of the battery information database shown in FIG. 1;

FIG. 5 shows an example of the structure of the terminal information database shown in FIG. 1;

FIG. 6 shows an example of the structure of a state-of-utilization information database (not shown) in which is stored the correspondence relationship between identification information of a terminal and state-of-utilization information of the terminal;

FIG. 7 shows an example of the structure of state-of-use information database (not shown) in which is stored the correspondence relationship between the serial numbers of batteries and the state-of-use information of batteries;

FIG. 8 shows an example of the external configuration of the terminal shown in FIG. 1;

FIG. 9 shows an example of the configuration of the terminal shown in FIG. 8;

FIG. 10 is a flow chart for explaining the connection process in the terminal having the configuration shown in FIG. 9;

FIG. 11 shows an example of a configuration in which the degree of amplification that is controlled in the amplification control unit shown in FIG. 9 can be changed from a center;

FIG. 12 shows the second embodiment of the battery exchange system of the present invention;

FIG. 13 is a sequence chart for explaining the battery exchange method in the battery exchange system shown in FIG. 12;

FIG. 14 shows an example of the structure of the user information database shown in FIG. 12;

FIG. 15 shows an example of the structure of the bicycle information database shown in FIG. 12; and

FIG. 16 shows an example of the structure of the charge amount information database shown information FIG. 12.

### EXEMPLARY EMBODIMENT

### First Embodiment

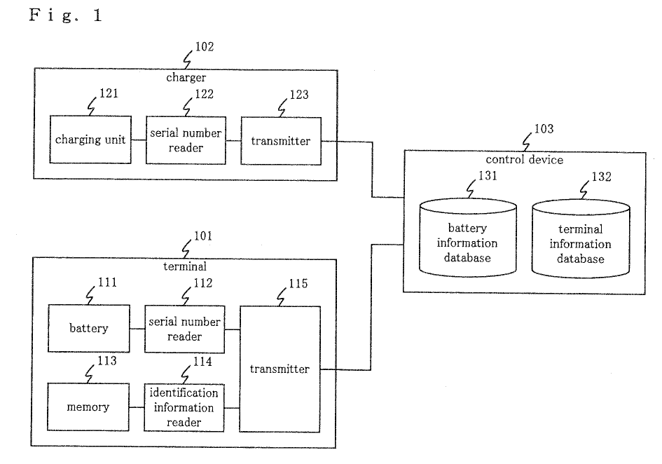

Referring to FIG. 1, the first embodiment of a battery exchange system is shown, the battery exchange system being made up of terminal 101, charger 102, and control device 103. Terminal 101 is a user device such as a portable terminal belonging to a user that uses this system. Charger 102 is a charging device for charging a chargeable battery that is installed in terminal 101. Control device 103 controls the charge state of the chargeable battery that is installed in terminal 101 and is provided to enable the transmission and reception of information between terminal 101 and charger 102.

In addition, terminal 101 is provided with: battery 111, serial number reader 112, memory 113, identification information reader 114, and transmitter 115. Battery 111 is a chargeable battery for supplying power to terminal 101 for operating terminal 101, battery 111 further being removable.

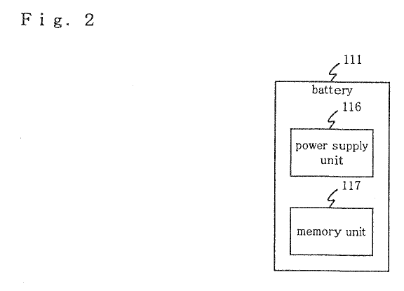

Battery 111 that is shown in FIG. 1 is shown in FIG. 2, battery 111 being made up of power supply unit 116 and memory unit 117. Power supply unit 116 supplies power to terminal 101 for causing terminal 101 to operate. Memory unit 117 stores a characteristic serial number for identifying battery 111.

Serial number reader 112 reads the serial number that is stored in advance in battery 111. Memory 113 is a memory unit for storing characteristic identification information for identifying terminal 101. Identification information reader 114 reads the identification information that is stored in memory 113. Transmitter 115 transmits to control device 103 the serial number that has been read by serial number reader 112 and the identification information that has been read by identification information reader 114. The transmission means may use radio such as PHS.

In addition, charger 102 is provided with charging unit 121, serial number reader 122, and transmitter 123. Charging unit 121 charges battery 111 that has been removed from terminal 101. Serial number reader 122 reads the serial number from battery 111 that has been charged by charging unit 121. Transmitter 123 transmits the serial number that was read by serial number reader 122 to control device 103.

Control device 103 is further provided with battery information database 131 and terminal information database 132. Battery information database 131 is a first database for storing information of battery 111. The structure of this component will be described in more detail later. Terminal information database 132 is a second database for storing information of terminal 101. The structure of this component will also be described in more detail hereinbelow.

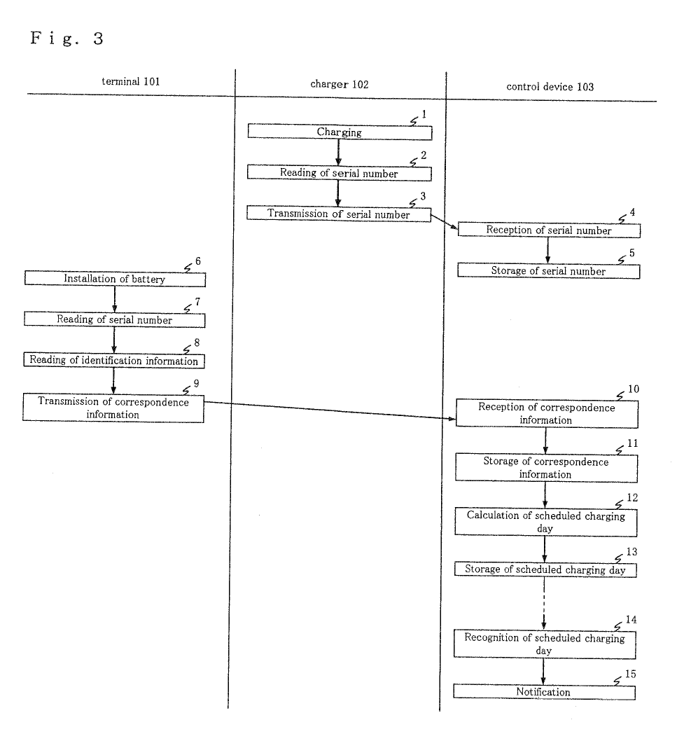

Explanation next regards the method of exchanging batteries in the battery exchange system of the above-described configuration with reference to FIG. 3.

First, in Step 1, the charging of battery 111 is carried out in charging unit 121 of charger 102. At this time, battery 111 is installed in charging unit 121 and charging is being carried out.

When charging of battery 111 has been completed in charging unit 121 of charger 102, the serial number is read from the battery 111 installed in charging unit 121 by serial number reader 122 in Step 2. The serial number read from battery 111 is a characteristic number that can identify battery 111 and is stored in advance in memory unit 117 when battery 111 was first manufactured.

When the serial number has been read by serial number reader 122 from battery 111 that is installed in charging unit 121, the serial number that has been read is transmitted from transmitter 123 to control device 103 in Step 3.

When the serial number transmitted from transmitter 123 is received in control device 103 in Step 4, the received serial number is stored in battery information database 132 in Step 5.

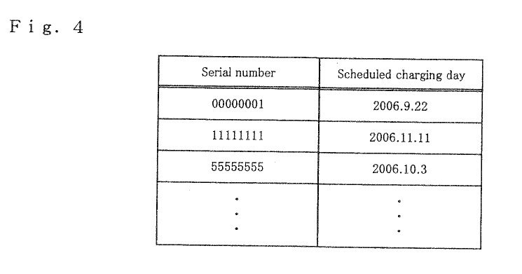

As shown in FIG. 4, charging information, in which the serial number and the next scheduled charging time are placed in correspondence with each other, is stored in battery information database 131 shown in FIG. 1. For the sake of convenience in this explanation, the scheduled charging time will be described as a scheduled charging day. The serial number is a serial number that was transmitted from charger 102 and received in control device 103. In addition, the scheduled charging day indicates the day on which the battery becomes has become depleted and requires charging (i.e. the day on which the battery should be charged, or the day on which the battery should be exchanged with another battery that has been charged), and this scheduled charging day will be explained in greater detail hereinbelow. At the stage of the initial completion of charging, only the serial number is stored.

When battery 111 is next installed in terminal 101 in Step 6, the serial number is read from battery 111 by serial number reader 112 in Step 7. At the same time, the identification information that is stored in advance in memory 113 is read by identification information reader 114 in Step 8. The identification information that is stored in advance in memory 113 may be characteristic information that can identify terminal 101, or may be the telephone number of terminal 101.

The serial number that has been read from battery 111 by serial number reader 112 and the identification information that has been read from memory 113 by identification information reader 114 are next placed in correspondence with each other and transmitted from transmitter 115 to control device 103 as correspondence information in Step 9.

When the correspondence information that has been transmitted from transmitter 115 of terminal 101 is received in control device 103 in Step 10, the received correspondence information is stored in terminal information database 132 in Step 11.

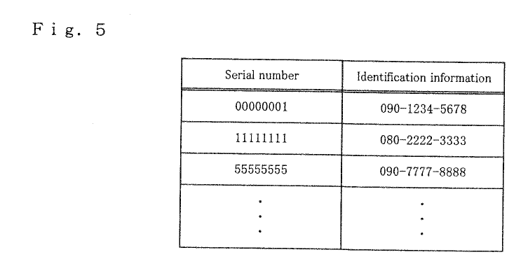

As shown in FIG. 5, the serial number and identification information are placed in correspondence with each other and stored in terminal information database 132 shown in FIG. 1. These items of information constitute correspondence information that has been transmitted from terminal 101. In other words, information is stored that indicates which battery 111 has been installed in which terminal 101. For example, the information that battery 111 for which the serial number is “00000001” is installed in terminal 101 for which the identification information is “090-1234-5678” is stored. In addition, the information that battery 111 for which the serial number is “11111111” is installed in terminal 101 for which the identification information is “080-2222-3333” is also stored in terminal 101. Still further, the information that battery 111 for which the serial number is “55555555” is installed in terminal 101 for which the identification information is “090-7777-8888” is also stored in terminal 101.

In Step 10, when the correspondence information that has been transmitted from transmitter 115 of terminal 101 has been received in control device 103, battery information database 131 is consulted in control device 103. More specifically, a determination is made as to whether the serial number contained in the correspondence information that was received in control device 103 is already stored in battery information database 131.

If it is determined that the serial number contained in the correspondence information that was received in control device 103 is already stored in battery information database 131, the process of Step 11 is carried out. The charging information that is indicated by this serial number and the scheduled charging day that has been placed in correspondence with this serial number are then deleted from battery information database 131.

On the other hand, if it is determined that the serial number contained in the correspondence information that was received in control device 103 is not stored in battery information database 131, it is recognized that battery 111 for which charging is not complete is installed in terminal 101, and this state is displayed by control device 103. At this time, the indicated information may also be the identification information of terminal 101 in which battery 111 which has this serial number is installed.

Alternatively, in Step 11, if correspondence information having the identification information that is contained in the correspondence information that is received in control device 103 is already stored in terminal information database 132, the already stored correspondence information is deleted. Further, the received correspondence information is stored in terminal information database 132, whereby the existence in terminal information database 132 of a plurality of items of correspondence information that contain the same identification information is prevented.

When correspondence information transmitted from transmitter 115 of terminal 101 is received in control device 103, the scheduled charging day of battery 111 is calculated in Step 12.

The scheduled charging day is calculated based on the time that the correspondence information transmitted from transmitter 115 of terminal 101 was received in control device 103 in Step 10, in other words, based on the time battery 111 was installed in terminal 101. For the sake of explanation, the scheduled charging day is here described as being calculated based on the day battery 111 was installed in terminal 101. For example, assuming the average life of battery 111 to be one month, if battery 111 is installed in terminal 101 on August 1, the scheduled charging day is calculated as September 1.

At this time, the scheduled charging day may be calculated by considering the time of reception that the serial number was received in Step 4. In other words, when the time from the reception time at which the serial number was received in Step 4 until the time the correspondence information was received in Step 10 (hereinbelow referred to as the “save time”) is longer than a time that was set in advance, the scheduled charging time may be calculated as an earlier time than a case in which the save time is shorter than the time that was set in advance. This provision takes into consideration the lower remained amount caused by self-discharge when the save time is longer than the time that was set in advance. When self-discharge is prevented by using any means, the reception time at which the serial number was received in Step 4 need not be considered. Alternatively, the scheduled charging day may be calculated using only the reception time at which the serial number was received in Step 4.

The above-described calculation method may be used when the state of use such as the frequency of use is to some extent the same in all terminals 101, but the scheduled charging time (scheduled charging day) may be calculated based on the state of use.

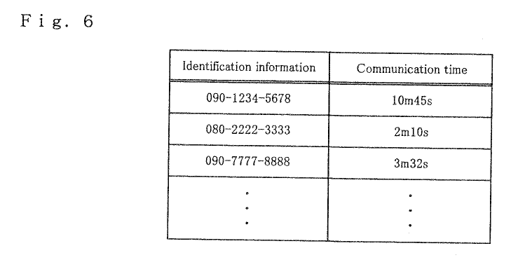

FIG. 6 shows the structure of a state-of-utilization information database in which the identification information of each terminal 101 is placed in correspondence with the communication time, which is state-of-utilization information. This state-of-utilization information database is provided in control device 103. For example, the communication time of terminal 101 for which the identification information is “090-1234-5678” is stored as the information “10 minutes 45 seconds.” The communication time of terminal 101 for which the identification information is “080-2222-3333” is stored as the information “2 minutes 10 seconds.” The communication time of terminal 101 for which the identification information is “090-7777-8888” is stored as the information “3 minutes and 32 seconds.” These items of state-of-utilization information are collected in control device 103 each time communication is carried out. These items of information may be taken into consideration when calculating the above-described scheduled charging day. Of course, the scheduled charging day of battery 111 that is installed in terminal 101 for which the communication time is short will fall on a day after the scheduled charging day of battery 111 that is installed in terminal 101 for which the communication time is long. The communication time in this case is the time that terminal 101 has communicated with control device 103, and the time that terminal 101 communicated with another device is not taken into consideration. As a result, terminal 101 is preferably a device that can communicate only with control device 103.

A state of use such as the length of use or frequency of use of battery 111 may be taken into consideration in the calculation of the scheduled charging day.

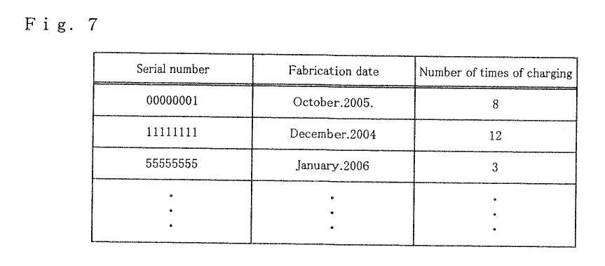

FIG. 7 shows the structure of a state-of-use information database in which the fabrication date of battery 111 and the number of times battery 111 has been charged in the past, which constitute the state-of-use information of battery 111, are placed in correspondence with the serial number of battery 111. This state-of-use information database is provided in control device 103. For example, the information stored for battery 111 having serial number “00000001” indicates that the fabrication date is October 2005 and that the number of times battery 111 has been charged in the past is “8.” The information stored for battery 111 having the serial number “11111111” indicates that the fabrication date is “December 2004” and that the number of times of charging in the past is “12.” The information stored for battery 111 having the serial number “55555555” indicates that the fabrication date is “January 2006” and that the number of times of charging in the past is “3.” These items of state-of-use information are collected in advance and updated in control device 103 each time charging is carried out. The above-described scheduled charging day may be calculated by taking these items of information into consideration. Of course, the scheduled charging date of battery 111, that has an earlier manufacturing date and that has more instances of charging in the past, will occur days before the scheduled charging date of battery 111 that has a later manufacturing date and that has fewer instances of charging in the past.

The scheduled charging day that is calculated as described above is stored in battery information database 131 in Step 13. In this case, the scheduled charging day is stored in the scheduled charging day of the structure of battery information database 131 shown in FIG. 4. For example, as shown in FIG. 4, the information “Sep. 22, 2006” is stored as the scheduled charging day of battery 111 having the serial number “00000001.” In addition, the information “Nov. 11, 2006” is stored as the scheduled charging day for battery 111 having the serial number “11111111.” The information “Oct. 3, 2006” is stored as the scheduled charging day of battery 111 having the serial number “55555555.” The scheduled charging day here indicates the day on which battery 111 that is installed in terminal 101 has run down and needs charging, and also indicates the exchange day on which battery 111 should be exchanged with another battery for which charging is complete.

Next, upon recognition in control device 103 in Step 14 of the arrival of a scheduled notification day, which is a preset number of days earlier than the scheduled charging day, a notification that prompts charging or an exchange of battery is carried out in Step 15. This notification may be displayed on a display unit (not shown) provided in control device 103. Using the serial number of that battery 111 as the search key, the identification information of terminal 101 in which target battery 111 is installed in this case may be searched in and read from terminal information database 132, and the identification information of terminal 101 that has been read may then be displayed. For example, if the next charging day is “October 1” and the number of days that has been set in advance is “3,” the scheduled notification day will be September 28, which is three days before “October 1,” and notification should be carried out on September 28.

As described in the foregoing explanation, the scheduled charging day of battery 111, or the day of replacing with another battery 111 is calculated based on the time that battery 111 was installed in terminal 101, and carrying out notification before this day can easily prevent battery shutoff of terminal 101.

Explanation next regards an example of using terminal 101 in which battery 111 that has been charged by the above-described method is installed. Explanation here regards an example in which terminal 101 belongs to a senior citizen who requires care.

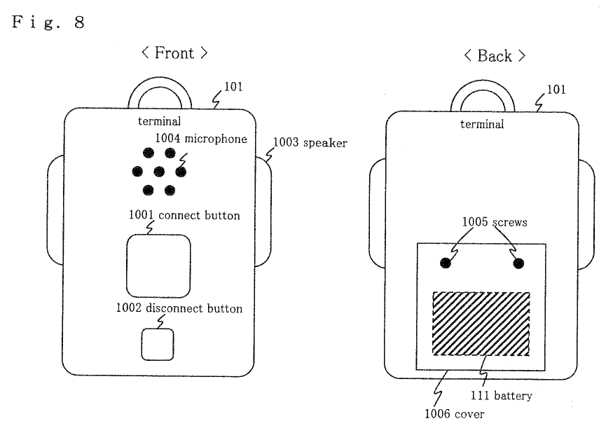

FIG. 8 shows the external appearance of terminal 101 shown in FIG. 1 that is made up from connect button 1001, disconnect button 1002, speaker 1003, microphone 1004, screws 1005, and cover 1006. Connect button 1001 is the button that is pressed when making a call to the center in which control device 103 is provided or when responding to an incoming call from the center. Disconnect button 1002 is the button that is pressed when disconnecting when communication is completed. Speaker 1003 is a typical voice output means for delivering voice that has been transmitted from the communication partner. Microphone 1004 is a typical sound collection device. Screws 1005 are screws that can be turned only by using a special tool so that the user cannot easily open cover 1006, although the present invention does not require a specialized form. Cover 1006 is a cover that is closed when battery 111 has been installed in terminal 101.

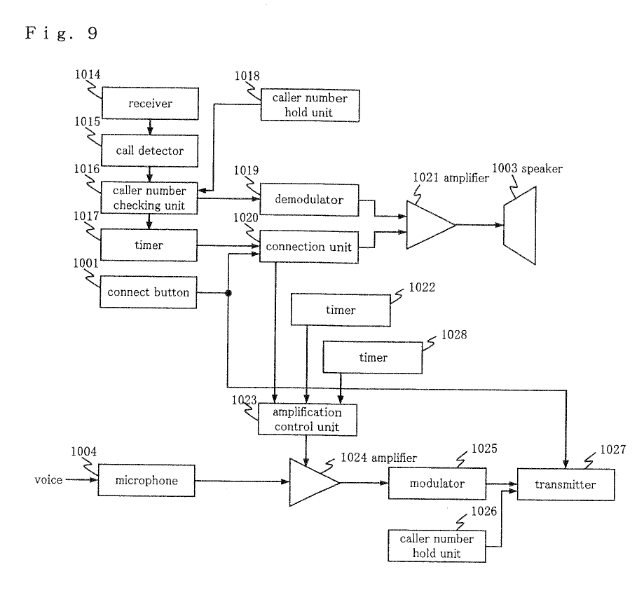

As shown in FIG. 9, terminal 101 shown in FIG. 8 includes: connect button 1001; speaker 1003; microphone 1004; receiver 1014; call detector 1015; caller number checking unit 1016; timers 1017, 1022, and 1028; caller number hold units 1018 and 1026; demodulator 1019; connection unit 1020, amplifiers 1021 and 1024; amplification control unit 1023; modulator 1025; and transmitter 1027. Receiver 1014 receives calls from the center. Call detector 1015 detects incoming calls that have been received by receiver 1014. Caller number checking unit 1016 checks the caller numbers for incoming calls that have been detected by Call detector 1015. Timers 1017, 1022, and 1028 are timers whose expiration times have been set in advance. Caller number hold unit 1018 holds in advance caller numbers that can connect to the call destination Demodulator 1019 demodulates voices that have been connected. Connection unit 1020 off-hooks terminal 101. Amplifiers 1021 and 1024 amplify voice. Amplification control unit 1023 controls the amplification of amplifier 1024. Modulator 1025 modulates the voice that has been amplified by amplifier 1024. Caller number hold unit 1026 holds the numbers of callers that terminal 101 can call. Transmitter 1027 transmits voices that have been modulated by modulator 1025 to the call destination.

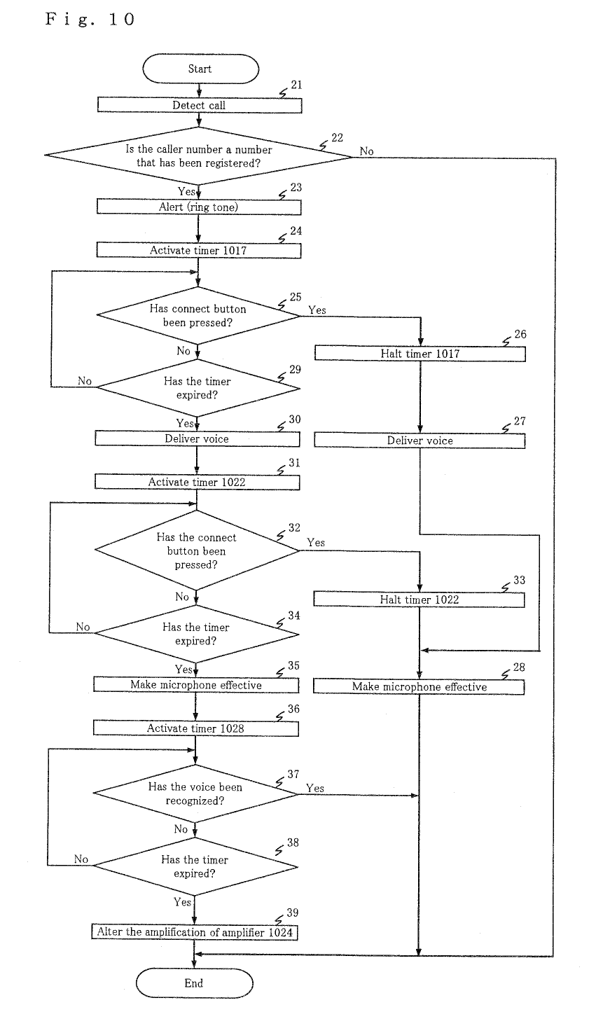

Referring to FIG. 10, explanation next regards the connection process in terminal 101 having the configuration shown in FIG. 9.

When a call from the center is received in receiver 1014, the call is detected in call detector 1015 in Step 21. The caller number for the detected call is checked by caller number checking unit 1016. At this time, it is determined in Step 22 whether the caller number is a number that has been registered in advance in caller number hold unit 1018.

If the caller number is not a number that has been registered in advance in caller number hold unit 1018, the process ends. In other words, connection is denied.

On the other hand, if it is determined that the caller number is a number that has been registered in advance in caller number hold unit 1018, an alert (ring tone) is started in Step 23 and timer 1017 is activated in Step 24.

It is next determined in Step 25 whether connect button 1001 has been pressed or not. When it is determined that connect button 1001 has been pressed, timer 1017 is halted in Step 26. Connection is then executed by connection unit 1020, whereby the voice that has been transmitted from the center is demodulated in demodulator 1019. The demodulated voice is amplified by amplifier 1021, following which the amplified voice is delivered from speaker 1003 in Step 27. In addition, by setting microphone 1004 to “effective,” the user's voice is collected by microphone 1004. The collected voice is amplified in amplifier 1024 at an amplification controlled by amplification control unit 1023. The amplified voice is modulated by modulator 1025. The modulated voice is then transmitted to the center from transmitter 1027 in Step 28.

On the other hand, if it is determined that connection button 1001 has not been pressed by the user in Step 25, it is determined in Step 29 whether timer 1017 has expired or not.

If it is determined that timer 1017 has not expired, the process of Step 25 is carried out.

On the other hand, when it is determined that timer 1017 has expired, call connection is carried out by connection unit 1020, whereby the voice that has been transmitted from the center is demodulated by demodulator 1019. The demodulated voice is amplified by amplifier 1021. The amplified voice is then delivered from speaker 1003 in Step 30. At the same time, timer 1022 is activated in Step 31.

It is then again determined in Step 32 whether connect button 1001 has been pressed or not. If it is determined that connect button 1001 has been pressed, timer 1022 is halted in Step 33. Microphone 1004 is then set to “effective,” whereby the user's voice is collected by microphone 1004. The collected voice is amplified by amplifier 1024 at an amplification that is controlled by amplification control unit 1023. The amplified voice is modulated by modulator 1025. The modulated voice is then transmitted to the center from transmitter 1027 in Step 28.

On the other hand, if it is determined in Step 32 that connect button 1001 has not been pressed by the user, it is then determined whether timer 1022 has expired or not in Step 34.

If it is determined that timer 1022 has not expired, the process of Step 32 is carried out.

On the other hand, if it is determined that timer 1022 has expired, microphone 1004 is set to “effective,” whereby the user's voice is collected by microphone 1004. The collected voice is amplified by amplifier 1024 at an amplification controlled by amplification control unit 1023. The amplified voice is modulated by modulator 1025. The modulated voice is then transmitted to the center from transmitter 1027 in Step 35. At the same time, timer 1028 is activated in Step 36.

It is next determined in Step 37 whether the voice that has passed by way of microphone 1004 has been recognized in the center. If it is determined that the voice has not been recognized, it is next determined in Step 38 whether timer 1028 has expired.

If it is determined that timer 1028 has not expired, the process of Step 37 is carried out.

On the other hand, if it is determined that timer 1028 has expired, the amplification of amplifier 1024 is altered by amplification control unit 1023 in Step 39. In other words, the amplification of voice that has been collected by microphone 1004 is raised such that even a small voice can be recognized in the center.

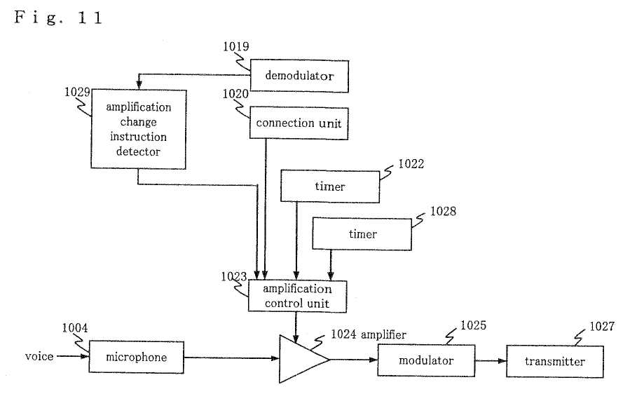

The expiration values of timers 1017, 1022, and 1028 and the amplification that is controlled by amplification control unit 1023 may be values that are set in advance, or may be values that can be altered from the center. The configuration shown in FIG. 11 is the configuration shown in FIG. 9 to which amplification change instruction detector 1029 has been added. When an amplification change instruction is transmitted from the center, the instruction is detected by amplification change instruction detector 1029 and the amplification is then set by amplification control unit 1023 based on the detected instruction.

### Second Embodiment

Explanation next regards the second embodiment of the battery exchange system of the present invention.

The present embodiment relates to the charging of a battery for lighting a lamp of a bicycle at night and targets a user who uses a bicycle to commute from a residence to a station, a school, or a workplace (hereinbelow referred to as “station”).

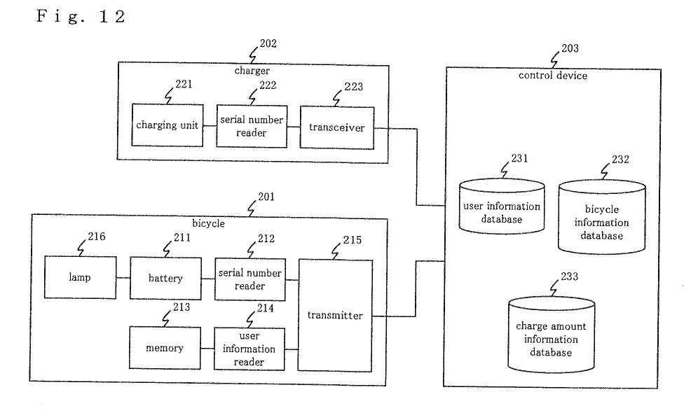

FIG. 12 shows the second embodiment of a battery exchange system that is made up from bicycle 201, charger 202, and control device 203. Bicycle 201 is a user device that is used by the user that uses this system. Charger 202 is a charging device for charging a chargeable battery that has been installed in bicycle 201 and is provided in the bicycle parking area of a station. Control device 203 controls the charged state of the chargeable battery that is installed in bicycle 201 and is connected to bicycle 201 and charger 202 to allow the transmission and reception of information between bicycle 201 and charger 202. In addition, bicycle 201 has a lamp that is lighted by the battery that has been installed.

Bicycle 201 is provided with: battery 211, serial number reader 212 memory 213, user information reader 214, transmitter 215, and lamp 216. Battery 211 is a chargeable battery for supplying power to lamp 216 for lighting lamp 216 and can be detached. The construction of battery 211 is similar to that of battery 111 explained in the first embodiment. Serial number reader 212 reads the serial number that is stored in advance in battery 211. Memory 213 is a memory for storing user information of the user (or owner) that uses bicycle 201. User information reader 214 reads the user information that is stored in memory 213. Transmitter 215 transmits to control device 203 the serial number that has been read by serial number reader 212 and the user information that has been read by user information reader 214. No particular stipulations apply to the transmission method in this case.

Charger 202 is provided with: charging unit 221, serial number reader 222, and transceiver 223. Charging unit 221 charges battery 211 that has been detached from bicycle 201. Serial number reader 222 reads the serial number from battery 211 that is charged by charging unit 221. Transceiver 223 transmits the serial number that has been read by serial number reader 222 to control device 203 and receives information about the amount of charge that has been transmitted from control device 203.

Control device 203 is further provided with user information database 231, bicycle information database 232, and charge amount information database 233. User information database 231 stores information relating to the user. The structure will be described in detail hereinbelow. Bicycle information database 232 stores information relating to bicycle 201. Again, this database will be described more specifically hereinbelow. Charge amount information database 233 stores the travel distance of bicycle 201 in correspondence with the amount of charge of battery 211 that is required for this travel distance.

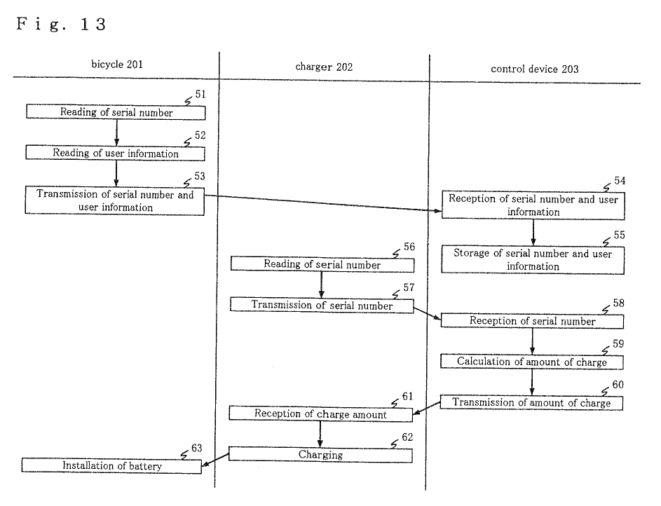

Explanation next regards the battery exchange method in the battery exchange system of the above-described configuration with reference to FIG. 13.

User information about the user is first stored in memory 213. This user information is information in which identification information that can identify the user (for example, the user's name) and information about the travel distance of bicycle 201 (for example the distance from a residence to a station) are placed in correspondence with each other.

In addition, user's registration of bicycle 201 is also required when first using the bicycle parking area.

The serial number that has been stored in advance in battery 211 is first read by serial number reader 212 in Step 51. In addition, user information that has been stored in advance in memory 213 is read by user information reader 214 in Step 52.

Next, the serial number that has been read from battery 211 by serial number reader 212 and the user information that has been read from memory 213 by user information reader 214 are transmitted from transmitter 215 to control device 203 in Step 53.

When the serial number and user information that have been transmitted from transmitter 215 of bicycle 201 are received in control device 203 in Step 54, the user information is stored in user information database 231 and the serial number and user name stored in the user information are stored in bicycle information database 232 in Step 55.

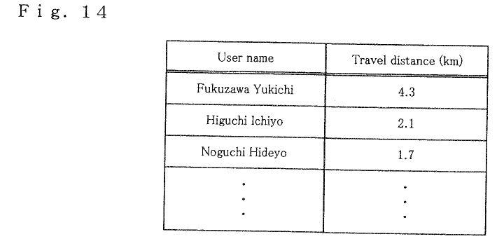

As shown in FIG. 14, the user name and travel distance are stored in correspondence with each other in user information database 231 shown in FIG. 12. These items of information are user information that is transmitted from bicycle 201. For example, information that the travel distance of bicycle 201 belonging to Mr. Fukuzawa Yukichi is 4.3 km is stored. In addition, information that the travel distance of bicycle 201 belonging to Ms. Higuchi Ichiyo is 2.1 km is stored. Still further, information that the travel distance of bicycle 201 belonging to Mr. Noguchi Hideyo is 1.7 km is stored.

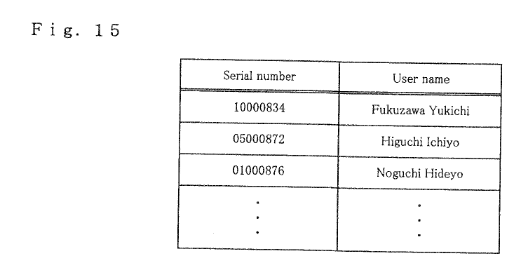

As shown in FIG. 15, the serial number of battery 211 and the user name are stored in correspondence with each other in bicycle information database 232 shown in FIG. 12. These items of information are the serial number transmitted from bicycle 201 and the user name contained in the user information. For example, information is stored that indicates that bicycle 201 in which battery 211 having the serial number “10000834” is installed is bicycle 201 that belongs to Mr. Fukuzawa Yukichi. Information is also stored that indicates that bicycle 201 in which battery 211 having the serial number “05000872” is installed is bicycle 201 belonging to Ms. Higuchi Ichiyo. Still further, information is stored that indicates that bicycle 201 in which battery 211 having the serial number “01000876” is installed is bicycle 201 that belongs to Mr. Noguchi Hideyo.

Then, when battery 211 is installed in charging unit 221 of charger 202 to charge battery 211, the serial number is read from battery 211 by serial number reader 222 in Step 56. The serial number that is read from battery 211 by serial number reader 222 is transmitted to control device 203 from transceiver 223 in Step 57.

When the serial number that is transmitted from transceiver 223 of charger 202 is received in control device 203 in Step 58, the amount of charge of the battery is calculated based on the received serial number in Step 59. A specific calculation method is described hereinbelow.

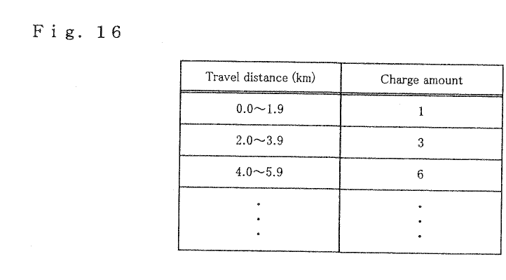

As shown in FIG. 16, the travel distance and the amount of charge are stored in correspondence with each other in charge amount information database 233 shown in FIG. 12. Here, the amount of charge required for lighting a lamp when traveling a particular travel distance is divided in steps. For example, the information stored indicates that the amount of charge required to light a lamp when traveling a travel distance of from 0.0 to 1.9 km is “1.” Further, information is stored indicating that the amount of charge required for lighting a lamp when traveling a travel distance of from 2.0 to 3.9 km is “3.” Still further, information is stored indicating that the amount of charge required for lighting a lamp when traveling a travel distance of from 4.0 to 5.9 km is “6.” These items of information are stored in advance. In addition, although simple integer values have been used for the amounts of charge shown in FIG. 16 for the sake of explanation, the amounts of charge may also be measured units.

Using the serial number received in control device 203 as a search key, the user name is searched within bicycle information database 232. Then, using the user name obtained as a result of the search as a search key, the travel distance is searched within user information database 231. Then, using the travel distance obtained as a result of the search as a search key, the amount of charge is searched within charge amount information database 233.

For example, if the serial number received in control device 203 is “10000834,” the user name that corresponds to serial number “10000834” within bicycle information database 232 shown in FIG. 15 is Mr. Fukuzawa Yukichi. Then, the travel distance corresponding to Mr. Fukuzawa Yukichi within user information database 231 shown in FIG. 14 is 4.3 km. Next, the amount of charge corresponding to a travel distance of 4.3 km within charge amount information database 233 shown in FIG. 16 is “6.” It is thus calculated that the amount to be charged in battery 211 for which the serial number is “10000834” is “6.”

Similarly, when the serial number received in control device 203 is “05000872,” the user name that corresponds to the serial number “05000872” within bicycle information database 232 is Ms. Higuchi Ichiyo. Then, the travel distance that corresponds to Ms. Higuchi Ichiyo within user information database 231 shown in FIG. 14 is 2.1 km Finally, the amount of charge that corresponds to the travel distance 2.1 km within charge amount information database 233 shown in FIG. 16 is “3.” It can thus be calculated that the amount to be charged in battery 211 for which the serial number is “05000872” is “3.”

In the same way, when the serial number received in control device 203 is “01000876,” the user name that corresponds to serial number “01000876” within bicycle information database 232 shown in FIG. 15 is “Mr. Noguchi Hideyo.” Next, the travel distance that corresponds to Mr. Noguchi Hideyo within user information database 231 shown in FIG. 14 is 1.7 km. The amount of charge that corresponds to the travel distance 1.7 km within charge amount information database 233 shown in FIG. 16 is “1.” It is thus calculated that the amount to be charged in battery 211 for which the serial number is “01000876” is “1.”

When the amount of charge of a battery is calculated based on the serial number that has been received in control device 203 as described above, the calculated amount of charge is transmitted to charger 202 in Step 60.

When the amount of charge that was transmitted from control device 203 to charger 202 is received in transceiver 223 of charger 202 in Step 61, the received amount of charge is charged in battery 211 in charging unit 221 in Step 62.

The charged battery 211 is then installed in bicycle 201 in Step 63.

Although explanation has been given using a case in which a one-day amount of charge is charged as the amount of charge, a similar method can be considered regarding a long-term charge of, for example, one month. In such a case, notification prompting charging similar to the first embodiment may be displayed in control device 203 on a day that is a preset number of days earlier than the day set for making a charge that will last one month. Still further, notification may be carried out by simultaneously displaying the user's name.

In addition, the user name need not actually be the user's name, but may be some other information or a number that can identify the user.

In addition to components that can execute the processes in the user device, the charging device, and the control device by means of the above-described dedicated hardware in the present invention, programs for realizing the functions of the present invention may be recorded on a recording medium that is readable by a user device, charging device, and control device, and these programs that have been recorded on a recording medium may then be read to the user device, the charging device, and the control device and then executed. The recording medium that is readable by a user device charging device, and control device may be a removable recording medium such as a floppy disk, a magneto-optical disk, a DVD, or a CD, or may be an HDD that is incorporated within a user device, charging device, and control device. The programs that are recorded in this recording medium may be read to control units (not shown) belonging to respective devices and processes identical to those described above then executed under the control of the control units. In this case, the control units belonging to each of the devices are components that operate as computers that execute programs that have been read from a recording medium onto which programs have been recorded.

According to the present invention, moreover, in a battery exchange system that includes: a user device that belongs to a user and that is supplied with power from a battery having a characteristic serial number, a charging device for charging the battery, and a control device for managing the state of battery charge, the control device carries out notification for prompting battery exchange at a time that precedes the scheduled charging time that has been stored by a preset interval.

In addition, when the serial number of the correspondence information that has been transmitted from the user device exists in the charging information, the control device deletes the serial number and the scheduled charging time that corresponds to that serial number from the charging information.

Alternatively, when the serial number included in the correspondence information that has been transmitted from the user device does not exist in the charging information, the control device displays the identification information that has been stored in correspondence with the serial number of the battery to carry out notification indicating that a battery in which charging is not complete has been installed.

The control device calculates the scheduled charging time of the battery having the serial number based on the time of reception of correspondence information that has been transmitted from the user device and state-of-utilization information of the user device that has been collected in a state-of-utilization information database.

The control device calculates the scheduled charging time of the battery having the serial number based on the time of reception of correspondence information that has been transmitted from the user device and state-of-use information of the battery that has been collected in a state-of-use information database.

Still further, the control device calculates the amount of charge that is charged in the battery having the serial number transmitted from the charging device based on user information which is information about the user, and transmits the calculated amount of charge to the charging device; and the charging device then reads the serial number from the battery when starting charging of the battery, transmits the serial number to the control device, and charges the battery to reach the calculated amount of charge that has been transmitted from the control device.

In addition, the battery includes a power supply unit for supplying power to the user device and a memory unit for storing the serial number.

The identification information is the telephone number of the user device.

In addition, the user device has characteristic identification information, and upon installation of a battery having a characteristic serial number, reads the serial number from the battery and places the identification information and the serial number in correspondence with each other and transmits this as correspondence information to the control device that manages the state of battery charge.

The charging device carries out charging of a battery having a characteristic serial number that has been installed in a user device belonging to a user, reads the serial number from the battery when charging of the battery has been completed, and transmits the serial number to the control device that manages the state of battery charge.

In addition, the charging device reads the serial number from the battery when starting charging of the battery, transmits the serial number to the control device, and then charges the battery having the serial number to reach the amount of charge, this amount of charge having been calculated in the control device based on the user information, which is information of the user.

In addition, the control device: receives and stores correspondence information from a user device to which power is supplied from a battery having a characteristic serial number, this correspondence information being information in which the serial number and identification information characteristic of the user device have been placed in correspondence with each other; receives the serial number transmitted from the charging device that carries out charging of the battery; based on the time of reception of the correspondence information that was transmitted from the user device, calculates the scheduled charging time that is next scheduled for the battery having the serial number; stores as charging information the serial number transmitted from the charging device and the scheduled charging time in correspondence with each other; and, before the scheduled charging time that has been stored, displays the identification information that has been stored in correspondence with the serial number of the battery to carry out notification prompting battery exchange.

The control device further carries out notification prompting battery exchange at a time that precedes, by a preset interval, the scheduled charging time that has been stored.

When the serial number included in the correspondence information that has been transmitted from the user device exists in the charging information, the control device deletes from the charging information the serial number and the scheduled charging time that has been placed in correspondence with the serial number.

When the serial number included in the correspondence information that was transmitted from the user device does not exist in the charging information, the control device displays the Identification information that is stored in correspondence with the serial number of that battery to carry out notification that a battery in which charging is not complete has been installed.

The control device further calculates the scheduled charging time of a battery having the serial number based on the time of reception of correspondence information that has been transmitted from the user device and the state-of-utilization information of the user device that is collected in the state-of-utilization information database.

The control device further calculates the scheduled charging time of the battery having the serial number based on the time of reception of the correspondence information that has been transmitted from the user device and the state-of-use information of the battery that is collected in the state-of-use information database.

The control device further calculates the amount of charge for charging a battery having the serial number transmitted from the charging device based on user information, which is information about the user.

In addition, the method of the present invention is a method in a battery exchange system that includes a user device that belongs to a user and to which power is supplied from a battery having a characteristic serial number, a charging device that carries out charging of the battery, and a control device that controls the state of battery charge; the method including steps in which:

the charging device reads the serial number from the battery when the charging of the battery is complete;

the charging device transmits the serial number to the control device; the user device reads the serial number from the battery when the battery is installed;

the user device places characteristic identification information that belongs to the user device and the serial number in correspondence with each other and transmits this as correspondence information to the control device;

the control device calculates a scheduled charging time that is next scheduled for the battery having the serial number transmitted from the charging device based on the time of reception at which the correspondence information transmitted from the user device was received;

the control device places in correspondence with each other the serial number transmitted from the charging device and the scheduled charging time and stores this as charging information; and

the control device, before the scheduled charging time, displays the identification information that has been placed in correspondence with the serial number of the battery to carry out notification prompting battery exchange.

A step is further included in which, at a time that precedes the scheduled charging time by a preset interval, the control device carries out notification prompting battery exchange.

A step is further included in which, when the serial number included in the correspondence information that was transmitted from the user device exists in the charging information, the control device deletes from the charging information the serial number and the scheduled charging time that was placed in correspondence with the serial number.

A step is further included in which, when the serial number included in the correspondence information transmitted from the user device does not exist in the charging information, the control device displays the identification information that was placed in correspondence with the serial number of the battery to carry out notification indicating that a battery for which charging is not complete has been installed.

A step is further included in which the control device calculates the scheduled charging time of the battery having the serial number based on the time of reception of correspondence information that has been transmitted from the user device and state-of-utilization information of the user device that is collected in the state-of-utilization information database.

A step is further included in which the control device calculates the scheduled charging time of the battery having the serial number based on the time of reception of correspondence information that has been transmitted from the user device and state-of-use information of the battery collected in the state-of-use information database.

In addition, steps are further included in which:

the charging device reads the serial number from the battery when starting charging of the battery;

the charging device transmits to the control device the serial number that has been read;

the control device calculates the amount of charge for charging the battery having the serial number that was transmitted from the charging device based on user information that is information about the user;

the control device transmits to the charging device the amount of charge that was calculated; and

the charging device charges the battery to reach the calculated amount of charge that was transmitted from the control device.

The recording medium of the present invention is a recording medium for recording a program for causing a user device, which is supplied with power from a battery having a characteristic serial number, and which has been manufactured to allow connection to a control device that manages the state of battery charge, and which has characteristic identification information, to execute processes of:

reading the serial number from the battery when the battery has been installed;

placing the identification information in correspondence with the serial number; and

transmitting information in which the identification information and the serial number have been placed in correspondence with each other as correspondence information to the control device.

Further, the recording medium of the present invention is a recording medium for recording a program for causing a charging device, which has been manufactured to allow connection to a control device that manages the state of battery charge having a characteristic serial number and that is installed in a user device belonging to a user and which carries out charging of the battery, to execute processes of:

reading the serial number from the battery when charging of the battery has been completed; and

transmitting the serial number to the control device.

In addition, the recording medium of the present invention records a program for further causing the charging device to execute processes of:

reading the serial number from the battery when starting charging of the battery;

transmitting the serial number to the control device; and

charging the battery having the serial number to reach an amount of charge that is calculated in the control device based on user information, which is information about the user.

In addition, the recording medium of the present invention is a recording medium for recording a program for causing a control device, which has been manufactured to enable connection to a user device that is provided with power from a battery having a characteristic serial number and connection to a charging device that carries out charging of the battery and which manages the states of battery charge, to execute processes of:

receiving and storing correspondence information that has been transmitted from the user device;

receiving the serial number that has been transmitted from the charging device;

calculating a scheduled charging time that is next scheduled for a battery having the serial number based on the time of reception of correspondence information that have been transmitted from the user device;

placing a serial number that has been transmitted from the charging device and the scheduled charging time in correspondence with each other and storing this as charging information; and

before the scheduled charging time that has been stored, displaying the identification information that has been stored in correspondence with the serial number of the battery to carry out notification prompting battery exchange.

In addition, the recording medium of the present invention records a program for further causing the control device to execute a process of, at a time that precedes the stored scheduled charging time by a preset interval, carrying out notification prompting battery exchange.

In addition, the recording medium of the present invention records a program for further causing the control device to execute a process of, when the serial number included in correspondence information that has been transmitted from the user device exists in the charging information, deleting from the charging information the serial number and the scheduled charging time that has been placed in correspondence with the serial number.

In addition, the recording medium of the present invention records a program for further causing the control device to execute a process of, when the serial number included in correspondence information that has been transmitted from the user device does not exist in the charging information, displaying the identification information stored in correspondence with the serial number of the battery to carry out notification indicating that a battery in which charging is not complete has been installed.

In addition, the recording medium of the present invention records a program for further causing the control device to execute a process of calculating the scheduled charging time of the battery having the serial number based on the time of reception of correspondence information that has been transmitted from the user device and state-of-utilization information about the user device that has been collected in a state-of-utilization information database.

In addition, the recording medium of the present invention records a program for further causing the control device to execute a process of calculating the scheduled charging time of the battery having the serial number based on the time of reception of correspondence information that has been transmitted from the user device and state-of-use information of the battery that has been collected in a state-of-use information database.

In addition, the recording medium of the present invention records a program for further causing the control device to execute a process of calculating an amount of charge for charging the battery having the serial number that has been transmitted from the charging device based on user information, which is information about the user.

While an exemplary embodiment of the present invention has been described in specific terms, such description is for illustrative purpose only, and it is to be understood that changes and variations may be made without departing from the spirit or scope of the following claims.

What is claimed is:

1. A battery exchange system comprises: a user device belonging to a user, said user device being supplied with power from a battery having a characteristic serial number; a charging device for charging said battery; and a control device for managing the state of said battery charge; wherein:
said user device has characteristic identification information, reads said serial number from said battery when said battery is installed, and places said identification information and said serial number in correspondence with each other and transmits as correspondence information to said control device;
said charging device reads said serial number from said battery when charging of said battery has been completed and transmits this serial number to said control device; and
said control device receives and stores correspondence information that has been transmitted from said user device, receives a serial number that has been transmitted from said charging device, calculates a scheduled charging time that is next scheduled for the battery having said serial number based on the time of reception of correspondence information that has been transmitted from said user device places in correspondence with each other the serial number that has been transmitted from said charging device and said scheduled charging time and stores this as charging information, and, before the scheduled charging time that has been stored, displays said identification information that is stored in correspondence with the serial number of that battery to carry out notification prompting battery exchange.

2. The battery exchange system according to claim 1, wherein said control device carries out notification prompting battery exchange at a time that precedes said stored scheduled charging time by a preset interval.

3. The battery exchange system according to claim 1, wherein, when the serial number included in the correspondence information that has been transmitted from said user device exists in said charging information, said control device deletes from said charging information the serial number and the scheduled charging time that has been placed in correspondence with the serial number.

4. The battery exchange system according to claim 3, wherein, when the serial number included in the correspondence information that has been transmitted from said user device does not exist in said charging information, said control device displays said identification information that is stored in correspondence with the serial number of that battery to carry out notification that a battery for which charging is not complete has been installed.

5. The battery exchange system according to claim 1, wherein said control device calculates a scheduled charging time of the battery having said serial number based on the time of reception of correspondence information that has been transmitted from said user device and state-of-utilization information of said user device that has been collected in a state-of-utilization information database.

6. The battery exchange system according to claim 1, wherein said control device calculates a scheduled charging time of the battery having said serial number based on the time of reception of correspondence information that has been transmitted from said user device and state-of-use information of said battery that has been collected in a state-of-use information database.

7. The battery exchange system according to claim 1, wherein;
said control device calculates an amount of charge for charging a battery having the serial number that was transmitted from said charging device based on user information, which is information about said user, and transmits said calculated amount of charge to said charging device; and
said charging device reads said serial number from said battery when starting charging of said battery, transmits said serial number to said control device, and charges said battery to reach the amount of charge that was transmitted from said control device.

8. The battery exchange system according to claim 1, wherein said battery comprises:
a power-supply unit for supplying power to said user device; and
a memory unit for storing said serial number.

9. The battery exchange system according to claim 1, wherein said identification information is the telephone number of said user device.

10. A user device that has characteristic identification information; that, upon installation of a battery having a characteristic serial number, reads said serial number from said battery; and that places said identification information and said serial number in correspondence with each other and transmits this as correspondence information to a control device that manages the state of said battery charge.

11. A charging device that carries out charging of a battery having a characteristic serial number that is installed in a user device that belongs to a user, that reads said serial number from said battery when charging of said battery has been completed, and that transmits the serial number to a control device that manages the state of said battery charge.

12. The charging device according to claim 11, wherein said charging device: reads said serial number from said battery when starting charging of said battery, transmits the serial number to said control device; and charges said battery having the serial number to reach the amount of charge, this amount of charge being calculated in said control device based on user information, which is information of said user.

13. A control device that:
receives and stores correspondence information in which a serial number and identification information have been placed in correspondence with each other and transmitted from a user device, said serial number being a characteristic serial number belonging to a battery that supplies power to said user device and said identification information being information characteristic of said user device;
receives said serial number that has been transmitted from a charging device that carries out charging of said battery;
calculates a scheduled charging time that is next scheduled for the battery having said serial number based on the time of reception of correspondence information that has been transmitted from said user device;
places in correspondence with each other the serial number that has been transmitted from said charging device and said scheduled charging time and stores this as charging information; and
before the scheduled charging time that has been stored, displaying said identification information that is stored in correspondence with the serial number of the battery to carry out notification prompting battery exchange.

14. The control device according to claim 13, wherein said control device carries out notification prompting battery exchange at a time that precedes said stored scheduled charging time by a preset interval.

15. The control device according to claim 13, wherein, when a serial number included in correspondence information that has been transmitted from said user device exists in said charging information, said control device deletes from said charging information the serial number and the scheduled charging time that has been placed in correspondence with the serial number.

16. The control device according to claim 15, wherein, when the serial number included in correspondence information that has been transmitted from said user device does not exist in said charging information, said control device displays said identification information that is stored in correspondence with the serial number of that battery to carry out notification indicating that a battery for which charging is not complete has been installed.

17. The control device according to claim 13, wherein said control device calculates a scheduled charging time of the battery having said serial number based on the time of reception of correspondence information that has been transmitted from said user device and state-of-utilization information of said user device that has been collected in a state-of-utilization information database.

18. The control device according to claim 13, wherein said control device calculates a scheduled charging time of the battery having said serial number based on the time of reception of correspondence information that has been transmitted from said user device and state-of-use information of said battery that has been collected in a state-of-use information database.

19. The control device according to claim 13, wherein said control device calculates the amount of charge that is needed for charging the battery having the serial number that was transmitted from said charging device based on user information, which is information about said user.

20. A method in a battery exchange system that is made up from a user device that belongs to a user and that is supplied with power from a battery having a characteristic serial number, a charging device for carrying out charging of said battery, and a control device for managing the state of said battery charge; said method comprising steps wherein:
said charging device reads said serial number from said battery when charging of said battery has been completed;
said charging device transmits said serial number to said control device;
said user device reads said serial number from said battery when said battery is installed;
said user device places characteristic identification information that belongs to said user device and said serial number in correspondence with each other and transmits this as correspondence information to said control device;
said control device calculates a scheduled charging time that is next scheduled for the battery having the serial number that was transmitted from said charging device based on the time of reception at which correspondence information transmitted from said user device is received;
said control device places the serial number transmitted from said charging device and said scheduled charging time in correspondence with each other and stores this as charging information; and
said control device, before said scheduled charging time, displays said identification information that has been placed in correspondence with the serial number of the battery to carry out notification prompting battery exchange.

21. The method according to claim 20, further comprising a step wherein said control device carries out notification prompting battery exchange at a time that precedes said scheduled charging time by a preset interval.

22. The method according to claim 20, further comprising a step wherein, when a serial number included in correspondence information that has been transmitted from said user device exists in said charging information, said control device deletes from said charging information the serial number and the scheduled charging time that has been placed in correspondence with the serial number.

23. The method according to claim 22, further comprising a step wherein, when a serial number included in correspondence information that has been transmitted from said user device does not exist in said charging information, said control device displays said identification information that was placed in correspondence with the serial number of the battery to carry out notification indicating that a battery for which charging is not complete has been installed.

24. The method according to claim 20, further comprising a step wherein said control device calculates a scheduled charging time of the battery having said serial number based on the time of reception of correspondence information that has been transmitted from said user device and state-of-utilization information of said user device that has been collected in a state-of-utilization information database.

25. The method according to claim 20, further comprising a step wherein said control device calculates a scheduled charging time of the battery having said serial number based on the time of reception of correspondence information that has been transmitted from said user device and state-of-use information of said battery that has been collected in a state-of-use information database.

26. The method according to claim 20, further comprising steps wherein:
said charging device reads said serial number from said battery when starting charging of said battery;
said charging device transmits said serial number that has been read to said control device;
said control device calculates the amount of charge that is needed for charging the battery having the serial number that was transmitted from said charging device based on user information, which is information about said user;
said control device transmits said calculated amount of charge to said charging device; and
said charging device charges said battery to reach the amount of charge that was transmitted from said control device.

27. A recording medium for recording a program for causing a user device, which is supplied with power from a battery having a characteristic serial number, and which is manufactured to allow connection to a control device for managing the state of said battery charge, and which has characteristic identification information, to execute processes of:
reading said serial number from said battery when said battery is installed;
placing said identification information and said serial number in correspondence with each other; and
transmitting information in which said identification information and said serial number have been placed in correspondence with each other as correspondence information to said control device.

28. A recording medium for recording a program for causing a charging device which is manufactured to allow connection with a control device for managing the state of battery charge having a characteristic serial number and which is installed in a user device that belongs to a user and which carries out charging of said battery, to execute processes of:
reading said serial number from said battery when charging of said battery is completed; and
transmitting said serial number to said control device.

29. The recording medium according to claim 28 for recording a program for causing said charging device to further execute processes of:
reading said serial number from said battery when starting charging of said battery;
transmitting said serial number to said control device; and
charging said battery having said serial number to reach the amount of charge, said amount of charge being calculated in said control device based on user information, which is information about said user.

30. A recording medium for recording a program for causing a control device, which is manufactured to allow connection to a user device that is supplied with power from a battery having a characteristic serial number and connection to a charging device that carries out charging of said battery and which manages the state of said battery charge, to execute processes of:
receiving and storing correspondence information that has been transmitted from said user device;
receiving said serial number that has been transmitted from said charging device;
calculating a scheduled charging time that is next scheduled for the battery having said serial number based on the time of reception of correspondence information that has been transmitted from said user device;
placing a serial number that has been transmitted from said charging device and said scheduled charging time in correspondence with each other and storing this as charging information; and
before said stored scheduled charging time, displaying said identification information that has been stored in correspondence with the serial number of the battery to carry out notification prompting battery exchange.

31. The recording medium according to claim 30 for recording a program for causing said control device to further execute a process of carrying out notification prompting battery exchange at a time that precedes said stored scheduled charging time by a preset interval.

32. The recording medium according to claim 30 for recording a program for causing said control device to further execute a process of, when a serial number included in correspondence information that has been transmitted from said user device exists in said charging information, deleting from said charging information the serial number and the scheduled charging time that has been placed in correspondence with that serial number.

33. The recording medium according to claim 32 for recording a program for causing said control device to further execute a process of, when a serial number included in correspondence information that has been transmitted from said user device does not exist in said charging information, displaying said identification information that is stored in correspondence with the serial number of the battery to carry out notification indicating that a battery for which charging is not complete has been installed.

34. The recording medium according to claim 30 for recording a program for causing said control device to further execute a process of calculating a scheduled charging time of the battery having said serial number based on the time of reception of correspondence information that has been transmitted from said user device and state-of-utilization information about said user device that has been collected in a state-of-utilization information database.

35. The recording medium according to claim 30 for recording a program for causing said control device to further execute a process of calculating a scheduled charging time of the battery having said serial number based on the time of reception of correspondence information that has been transmitted from said user device and state-of-use information of said battery that has been collected in a state-of-use information database.

36. The recording medium according to claim 30 for recording a program for causing said control device to further execute a process of calculating the amount of charge that is needed for charging the battery having a serial number that has been transmitted from said charging device based on user information, which is information about said user.
